(19) United States
(12) Patent Application Publication
(10) Pub. No.: US 2011/0013609 A1
(43) Pub. Date: Jan. 20, 2011

(54) METHOD FOR A MORE EFFICIENT SEARCH FOR RADIO NETWORK ACCESS POINTS FOR CLOSED GROUPS IN RADIO ACCESS NETWORKS

(76) Inventors: Sebastian Speicher, Bonn (DE); Karl-Heinz Nenner, Bornheim (DE)

Correspondence Address: Law Offices of Robert F. Zielinski, LLC, 1518 Walnut Street, Suite 1706, Philadelphia, PA, 19102, US

(21) Appl. No.: 12/808,632

(22) PCT Filed: Oct. 30, 2008
(86) PCT No.: PCT/EP08/09156

§ 371 Date: Sep. 14, 2010

(30) Foreign Application Priority Data
Dec. 21, 2007 (DE) 10 2007 062 840.6

(51) Int. Cl. H04W 48/20

(52) U.S. Cl. 370/338

(57) ABSTRACT

The invention relates to a method for identifying access points for a closed group of mobile radio devices to a cellular mobile radio network, wherein the use of said access points is authorized only for the closed group of mobile radio devices, wherein the data from a neighboring cell are transmitted to a mobile radio device checked into said cell by a cell forming such an access point, and/or a search for currently receivable neighboring cells is performed by the mobile radio device checked into said cell, the data from the neighboring cell are stored at least temporarily in the mobile radio device, and a search for the access point is initiated if the mobile radio device is present within range of one or more neighboring cells, wherein, in case the access point is not found, a renewed search for the access point is performed by the mobile radio device if the geographic position of the mobile radio device has changed significantly relative to a previous position, within the range of the neighboring cells.

The invention relates to a method for identification of access points for a closed group of cellular terminals to a cellular land mobile network, the use of these access points being cleared only for the closed group of cellular terminals.

Standardized mechanisms for mobile link assignment prevent uncontrolled access to selected mobile network access points for closed subscriber groups (CSG), i.e. only members of the closed subscriber group (hereinafter also called CSG) are authorized to use the associated cellular network access point(s), i.e. suitable cells which can be used as the access point for the closed subscriber group, hereinafter called CSG cell(s). Permission to use a CSG cell is based on a subscription and is stored in the cellular terminal and/or the subscriber identity module (SIM).

The prior art is furthermore that cellular terminals autonomously search for these CSG cells. In this connection, if available, information which has been emitted by macrocells (so called vicinity lists) about adjacent CSG cells can be used. Optionally the search is furthermore limited to the region surrounding the CSG cell (for example defined by the location/routing/tracking area).

The described approach that macrocells emit information about adjacent CSG cells and the cellular terminal uses it as a basis for searching for available CSG cells, means, especially in the case of a larger number of suitable cells, i.e. CSG cells, in the network, an immense operating cost because the corresponding vicinity relations must be permanently serviced. Furthermore the required number of CSG cells would quickly exceed the technically possible number of adjacent cell relations which a macrocell can emit. Furthermore, this approach is not possible when network customers can procure and install a CSG cell autonomously, therefore without direct participation of the network operator.

Moreover, in this approach its inexactness is a problem. Since macro-cellular network access points can have a very great range, a search with high probability is initiated although there is still no suitable CSG cell in range of the cellular terminal. In this case it has only been possible in the past to periodically repeat the search in certain time intervals. But for a time interval selected to be short, this leads to high energy consumption (due to the frequent search processes), and for an interval chosen to be long, to a delay which is unacceptable from the user standpoint until actual detection of an existing and suitable CSG cell.

The limitation of the search to the region surrounding the CSG cell cannot solve the aforementioned problem of inexactness since the definition of the region comprises several to many macrocells. Only in this way is it possible to prevent the terminal from always searching for a CSG cell although it is located outside the surrounding region and thus is surely outside the receiving region of the CSG cell. Anyway, servicing of the relations between the region and the CSG cell by the network operator is technically and administratively no longer possible to the extent the aforementioned circumstance prevails that a large number of CSG cells is located in the network and/or the network customers can autonomously commission CSG cells.

The object of the invention is to make available a method which overcomes the indicated disadvantages of the prior art and makes available an improved mechanism for initiating a search process for a suitable CSG cell on the side of the cellular terminal.

This object is achieved as claimed in the invention by a method as claimed in claim 1. Other advantageous embodiments of the invention are given in the dependent claims.

In the method for identification of access points for a closed subscriber group of cellular terminals to a cellular land mobile network is especially advantageous [sic], the use of these access point being cleared only for the closed group of cellular terminals,
that on the side of the cell which forms such an access point the data of adjacent cells are transmitted to a cellular terminal which has checked into the land mobile network in this cell and/or that on the side of the cellular terminal which has checked into the land mobile network in this cell a search for adjacent cells which can be received instantaneously is carried out,
that the data of adjacent cells are stored at least temporarily in the cellular terminal, and
that a search for cells which are suitable as the access point for the closed subscriber group is initiated when the cellular terminal is in range of one or more adjacent cells of an access point for a closed subscriber group,
that if the access point for the closed subscriber group has not been found, a repeated search for the access point is carried out by the cellular terminal when within range of the adjacent cells of the access point the geographical position of the cellular terminal has changed significantly to a previous position.

The new approach as claimed in the invention consists of an improved mechanism and method for initiating a process for searching for a suitable CSG cell on the side of the cellular terminal.

This method is likewise based on the fundamental idea of using vicinity information. Thus, a search for suitable CSG cells, i.e. those cells which can be received and which can be used as the access point to the land mobile network for the closed subscriber group, can be carried out when the cellular terminal is within range of one/several macrocells which are known to the cellular terminal as neighboring the CSG cell.

The difference from the prior art and the special advantage of the method as claimed in the invention are however (a) how the cellular terminal learns these vicinity relations of suitable CSG cells, (b) that the inaccuracy of the adjacent cell list with respect to the receiving region of the CSG cell is distinctly reduced, and (c) that after a failed search attempt a repeated search is done as soon as the position of the cellular terminal has changed significantly, but it is still located within range of the adjacent cells of the access point.

If the cellular terminal is however outside the range of the known adjacent cells of the access point, i.e. at any remote location within the land mobile network, a search for an access point is unnecessary. In other words, a search for the access point for the closed subscriber group, for example a so-called home base station, is only started when there is any possibility at all that the cellular terminal of the closed subscriber group is located in range of this access point.

The concept of a suitable CSG cell means a cell of the land mobile network which can be used by the closed subscriber group of cellular terminals as the access point to the land mobile network, i.e. that it is possible in these suitable cells for the cellular terminals belonging to the closed subscriber group (CSG) to check into the land mobile network and to establish and maintain cellular connections, i.e. for example to actively initiate the establishment of cellular connections (call set-up) or to accept a call (call acceptance) or to establish and/or maintain data circuits.

The data of adjacent cells of suitable CSG cells are detected alternatively or cumulatively in that on the side of the cell which forms a suitable CSG cell the data of adjacent cells are transmitted to the cellular terminal which has checked into the land mobile network in this cell and/or that a search for instantaneously receivable adjacent cells is carried out on the side of a cellular terminal which has checked into the land mobile network in this cell.

A suitable adjacent cell can likewise be a CSG cell, i.e. a cell which is cleared only for a closed subscriber group, or also a macrocell of the cellular land mobile network, i.e. a cell which is generally available to users of the land mobile network.

A search by the cellular terminal can thus be initiated especially when a previous search has been unsuccessful, but in the meantime a significant change in the position of the cellular terminal has taken place and therefore it is possible to again have traveled in range of a suitable CSG cell or public cell.

Thus, there are two possibilities which can be used alternatively or cumulatively for learning or detecting vicinity relations:
1) The cellular terminal is located in the CSG cell, and the latter knows the adjacent macrocells (for example based on its own scan of the vicinity). In this case the CSG cell can transmit this information to the cellular terminal, for example by the broadcast channel or alternatively by dedicated signalling, i.e. that the data of adjacent cells are transmitted to the cellular terminal which belongs to the closed subscriber group by the CSG cell in which the cellular terminal is located and in which it has checked into the land mobile network.
2) The cellular terminal determines by cell searching (for example the background search which takes place cyclically) the instantaneously receivable macrocells and stores all these cells, as long as the CSG cell, i.e. the current cell and the cell being used as the access point, can likewise be received, as neighbors.

With this adjacent cell list the geographical region for a CSG cell search, i.e. for a search for cells suitable for the closed subscriber group as the access point to the land mobile network, is more exactly determined so that the probability of an unsuccessful search, and associated therewith the frequency of searching, is clearly reduced.

Preferably a search for receivable adjacent cells is carried out by the CSG cell, especially is repeatedly done at definable time intervals, and the data of these receivable adjacent cells are transmitted to the cellular terminals of the closed subscriber group which have checked in in the cell.

Alternatively or cumulatively, in one preferred embodiment of the method on the side of the cellular terminal of the closed subscriber group, as long as it has checked into the land mobile network via a suitable CSG cell, a search for receivable adjacent cells is done repeatedly at definable time intervals, and the instantaneously receivable adjacent cells are at least temporarily stored as adjacent cells in the cellular terminal.

A position change of the cellular terminal can be established especially with one of the following methods:

Preferably a significant change of the geographical position of the cellular terminal can be established by the change of a timing advance value of a time division multiplexing method which has been assigned to the cellular terminal from the access point reaching or exceeding a definable value, especially reaching or exceeding it within a definable time interval.

If the land mobile network uses a time division multiplexing method, a timing advance value is communicated to each cellular terminal. The value describes the time by which transmissions of the cellular terminal are to be brought forward in time in order to equalize propagation delays based on the distance between the cellular terminal and mobile network access point. The timing advance value is adapted accordingly when this distance/propagation delay changes.

On this basis, as claimed in the invention a repeated search for suitable CSG cells can be done especially when the timing advance value which has been assigned to the cellular terminal changes by a predefined or dynamically determined relative or absolute value, especially within a predefined time interval. The initiation criterion can thus be a definable absolute value and/or a gradient of the timing advance value.

In addition and/or alternatively a periodic search for suitable CSG cells can be carried out, but especially—as long as the timing advance value does not change as described above—with a greater time interval between the individual search processes.

Alternatively or cumulatively a significant change in the geographical position of the cellular terminal can be established by the change of the absolute or relative location (relative to the frame structure) of broadcast information of receivable cells reaching or exceeding a definable value, especially reaching or exceeding it within a definable time interval.

Cellular devices continuously receive broadcast information from cells in range. This information must be regularly decoded by the terminal. So that this succeeds, the terminal must be synchronized to the frame structure (link layer) of the broadcast signal, the time position of the frames—relative to the instant of emission by the cell—resulting from the transit time of the signal to the terminal, and thus the distance between the cell and terminal. For the case in which the terminal is moving toward the cell or away from it, the synchronization information must be tracked accordingly.

On this basis, as claimed in the invention the repeated search for suitable CSG cells can be carried out especially when the synchronization information with respect to the frame of one or more macrocells changes by a predefined or dynamically determined relative or absolute value within a predefined time interval.

Additionally and/or alternatively a periodic search for suitable CSG cells can furthermore be carried out, but especially—as long as synchronization information does not change as described above—with a greater time interval between the individual search processes.

Alternatively, instead of changes of the synchronization information, changes of the relative location of the frames of several macrocells among one another can be used.

The initiation criterion can thus be a definable absolute value and/or a gradient of the synchronization information or the relative location of the frames (link layer) to one another.

Alternatively or cumulatively to the aforementioned possibilities of establishing a position change of the cellular terminal which is significant for the purposes of the invention, by which a search for cells which are suitable as the access point for the closed subscriber group is initiated by the cellular terminal, a significant change in the geographical position of the cellular terminal can be ascertained by a change of the reception level and/or the reception quality of one or more receivable cells reaching or exceeding a definable time interval, especially reaching or exceeding it within a definable time interval.

Cellular terminals generally measure the properties of the signal which has been received from the receivable macro-cellular network access points (for example reception level and/or reception quality).

As claimed in the invention the repeated search for suitable CSG cells can be carried out when the properties of the measured signal of one or more predefined macro-cellular network access points change by a predefined or dynamically determined relative or absolute value within a predefined time interval.

The initiation criterion can thus also be a definable absolute value and/or a gradient of the reception quality and/or of the reception level of the radio signal of adjacent cells.

A search for suitable CSG cells can also be carried out, i.e. initiated, as soon as one or more of the indicated initiation conditions occur since they can also be evaluated and monitored in parallel.

1. A method for identification of access points for a closed subscriber group of cellular terminals to a cellular land mobile network, the use of these access points being cleared only for the closed group of cellular terminals, wherein
on the side of a cell which forms such an access point, the data of adjacent cells are transmitted to a cellular terminal which has checked into the land mobile network in this cell and/or on the side of the cellular terminal which has checked into the land mobile network in this cell, a search for adjacent cells which can be received instantaneously is carried out; and wherein
the data of adjacent cells are stored at least temporarily in the cellular terminal, and
a search for the access point for the closed subscriber group is initiated when the cellular terminal is in range of one or more adjacent cells of an access point for a closed subscriber group; and further wherein
if the access point for the closed subscriber group has not been found, a repeated search for the access point is carried out by the cellular terminal when within range of the adjacent cells of the access point the geographical position of the cellular terminal has changed significantly to a previous position.

2. A method as claimed in claim 1, wherein on the side of the cell a search for receivable suitable adjacent cells is carried out, especially is repeatedly done at definable time intervals, and the data of these receivable suitable adjacent cells are transmitted to the cellular terminals of the closed subscriber group which have checked in the cell.

3. A method as claimed in claim 1, wherein on the side of the cellular terminal of the closed subscriber group, a search for receivable and suitable adjacent cells is done repeatedly at definable time intervals, and the instantaneously receivable adjacent cells are at least temporarily stored as adjacent cells in the cellular terminal

4. A method as claimed in claim 1, wherein a significant change of the geographical position of the cellular terminal is established by a change of a timing advance value of a time division multiplexing method which has been assigned to the cellular terminal from the access point reaching or exceeding a definable value, especially reaching or exceeding it within a definable time interval.

5. A method as claimed in claim 1, wherein a significant change in the geographical position of the cellular terminal is established by the change of the absolute or relative location relative to the frame structure of broadcast information of receivable cells reaching or exceeding a definable value, especially reaching or exceeding it within a definable time interval.

6. A method as claimed in claim 1, wherein a significant change of the geographical position of the cellular terminal is established by the change of the reception level and/or a corresponding averaged value of the reception level and/or the quality of the received signal and/or a corresponding averaged value of the quality of the received signal of one or more receivable cells reaching or exceeding a definable time interval, especially reaching or exceeding it within a definable time interval.

7. A method as claimed in claim 2, wherein on the side of the cellular terminal of the closed subscriber group, a search for receivable and suitable adjacent cells is done repeatedly at definable time intervals, and the instantaneously receivable adjacent cells are at least temporarily stored as adjacent cells in the cellular terminal.

8. A method as claimed in claim 2, wherein a significant change of the geographical position of the cellular terminal is established by a change of a timing advance value of a time division multiplexing method which has been assigned to the cellular terminal from the access point reaching or exceeding a definable value, especially reaching or exceeding it within a definable time interval.

9. A method as claimed in claim 2, wherein a significant change in the geographical position of the cellular terminal is established by the change of the absolute or relative location relative to the frame structure of broadcast information of receivable cells reaching or exceeding a definable value, especially reaching or exceeding it within a definable time interval.

10. A method as claimed in claim 2, wherein a significant change of the geographical position of the cellular terminal is established by the change of the reception level and/or a corresponding averaged value of the reception level and/or the quality of the received signal and/or a corresponding averaged value of the quality of the received signal of one or more receivable cells reaching or exceeding a definable time interval, especially reaching or exceeding it within a definable time interval.
